(19) United States
(12) Patent Application Publication
(10) Pub. No.: US 2025/0313253 A1
(43) Pub. Date: Oct. 9, 2025

(54) FOLDING MECHANISM AND STROLLER

(71) Applicant: WONDERLAND SWITZERLAND AG, Steinhausen (CH)

(72) Inventors: Erxue Wang, Dongguan (CN); Chenchen Sun, Dongguan (CN)

(21) Appl. No.: 19/097,945

(22) Filed: Apr. 2, 2025

(30) Foreign Application Priority Data
Apr. 3, 2024 (CN) 202410405823.6
Aug. 2, 2024 (CN) 202411063167.2

(51) Int. Cl. B62B 7/06; B62B 7/08; B62B 7/10

(52) U.S. Cl. CPC B62B 7/062; B62B 7/08; B62B 7/10

(57) ABSTRACT

A folding mechanism includes a first connecting base, a second connecting base, and a damping member. The second connecting base is connected to the first connecting base and is rotatable between a first rotation position and a second rotation position relative to the first connecting base. The damping member is arranged between the first connecting base and the second connecting base, and the damping member is connected to the first connecting base. When the second connecting base rotates relative to the first connecting base, the damping member and the second connecting base rotate relative to each other, and in at least one stage during the relative rotation of the second connecting base and the first connecting base, at least part of the damping member in a circumferential direction abuts against a circumferential inner wall of the second connecting base.

### CROSS REFERENCE TO RELATED APPLICATIONS

This application claims priorities of Chinese Patent Application No. 2024104058236, entitled “FOLDING MECHANISM AND STROLLER”, filed on Apr. 3, 2024, and Chinese Patent Application No. 2024110631672, entitled “FOLDING MECHANISM AND STROLLER”, filed on Aug. 2, 2024, the entire contents of which are incorporated herein by reference.

### TECHNICAL FIELD

The present disclosure relates to the field of stroller technologies, and in particular, to a folding mechanism and a stroller.

### BACKGROUND

Strollers, such as wagon carts and child strollers, are favored by consumers due to their dual functionality of providing seating for infants and toddlers as well as carrying items. For convenience of use, generally, these strollers can be folded and unfolded. However, for the strollers currently on the market, when frames are folded or unfolded, collisions between structures of the strollers are likely to occur, and there is a possibility that the structures of the strollers may be damaged by impact. Therefore, it is necessary to design a new frame to at least reduce the possibility that the structures of the stroller are damaged by impact during folding or unfolding.

### SUMMARY

Based on this, it is necessary to provide a folding mechanism and a stroller in order to solve the problem of excessive rotation speed of the handlebar when the frame is folded or unfolded, which may cause the handlebar to collide with the stroller and be damaged.

According to one aspect of the present disclosure, a folding mechanism is provided. The folding mechanism includes: a first connecting base; a second connecting base connected to the first connecting base and rotatable between a first rotation position and a second rotation position relative to the first connecting base; and a damping member arranged between the first connecting base and the second connecting base. The damping member is connected to the first connecting base. When the second connecting base rotates relative to the first connecting base, the damping member and the second connecting base rotate relative to each other, and in at least one stage during the relative rotation of the second connecting base and the first connecting base, at least part of the damping member in a circumferential direction abuts against a circumferential inner wall of the second connecting base.

In an embodiment, the second connecting base is provided with a cavity, and at least part of the damping member is located in the cavity; and along a direction of relative rotation of the first connecting base and the second connecting base, an outer peripheral side edge of the damping member is provided with a protruding portion protruding outward, the protruding portion is configured to abut against a circumferential inner wall of the second connecting base located at an edge of the cavity in at least one stage during the relative rotation of the second connecting base and the first connecting base.

In an embodiment, the inner wall of the second connecting base located at the edge of the cavity is provided with a friction portion protruding inward, the friction portion is configured to be in interference fit with the protruding portion in at least one stage during the relative rotation of the second connecting base and the first connecting base.

In an embodiment, an edge of one of the protruding portion and the friction portion is in a shape of a convergent arc along a first direction, and another of the protruding portion and the friction portion is a protruding pillar.

In an embodiment, edges of the protruding portion and the friction portion are in shapes of convergent arcs along a first direction.

In an embodiment, an edge of one of the inner wall of the second connecting base and the protruding portion is in the shape of a convergent arc along a first direction, and an edge of another of the inner wall of the second connecting base and the protruding portion is in the shape of a ring.

In an embodiment, a side of the first connecting base facing the second connecting base is provided with a first boss, an end of the first boss adjacent to the second connecting base is provided with a fixing groove, and the damping member is provided with a bump, the bump is nested in the fixing groove so that the damping member is fixed to the first connecting base.

In an embodiment, the damping member is an elastic member.

In the above-mentioned folding mechanism, the damping member is arranged between the first connecting base and the second connecting base. When the handlebar rotates with the second connecting base relative to the first connecting base, the damping member can decrease a rotation speed of the handlebar, which can prevent a violent collision between the handlebar and the leg assembly, thereby protecting the handlebar and the leg assembly and improving durability of the stroller.

According to another aspect of the present disclosure, another folding mechanism is provided. The other folding mechanism includes: a first connecting base provided with a friction portion protruding inward from an inner wall of the first connecting base; a second connecting base connected to the first connecting base and rotatable between a first rotation position and a second rotation position relative to the first connecting base; and a damping member arranged on the second connecting base, in at least one stage during the relative rotation of the second connecting base and the first connecting base, the damping member abutting against the friction portion to decrease a speed of relative rotation of the second connecting base and the first connecting base.

In an embodiment, the damping member includes a damping portion, and in at least one stage during the relative rotation of the second connecting base and the first connecting base, the damping portion abuts against the friction portion.

In an embodiment, the damping member further includes a limiting portion including: a connection section extending from one side of the damping portion; and a limiting portion body connected to the connection section. The limiting portion body is generally a straight section. When the first connecting base and the second connecting base rotate relative to each other until the friction portion is opposite to the limiting portion, the friction portion falls into the limiting portion body, and the connection section and the limiting portion body prevent a relative rotation of the first connecting base and the second connecting base in an opposite direction.

In an embodiment, the damping member further includes a first connecting portion, which is provided with a mounting groove, and is arranged on at least one end of two ends of the damping member in a length direction. The second connecting base is provided with a second connecting portion, which is embedded into the mounting groove, so that the damping member is fixed to the second connecting base.

In an embodiment, the second connecting base is further provided with an abutting member, which is spaced apart from the second connecting portion, and a part of the first connecting portion is arranged between the second connecting portion and the abutting member.

In an embodiment, the damping member is further provided with a close-fitting member, which is arranged on the first connecting portion, and is pressed and arranged between the second connecting portion and the first connecting portion.

In an embodiment, an end of the close-fitting member is connected to a surface of the first connecting portion, and the close-fitting member is arranged at an angle relative to the surface of the first connecting portion.

In an embodiment, the close-fitting member is elastic, and when the close-fitting member is pressed, the angle decreases, and the close-fitting member generates an elastic restoring force that causes the angle to have a tendency to restore.

In an embodiment, the second connecting base includes: a first chamber configured to engage with a locking member; and a second chamber. The damping member is mounted in the second chamber.

In an embodiment, a stopper is arranged in the second chamber. When the first connecting base rotates relative to the second connecting base, the stopper is capable of abutting against the friction portion to limit a movement stroke of the first connecting base relative to the second connecting base.

In an embodiment, the damping portion has a convergent arc shape along the second direction.

According to yet another aspect of the present disclosure, a stroller is provided. The stroller includes: the above-mentioned folding mechanism; a leg assembly connected to the first connecting base, the leg assembly including a front leg and a rear leg arranged at an angle; and an elastic member, two ends of the elastic member being connected to the front leg and the rear leg respectively, so that the angle formed by the front leg and the rear leg has a tendency to decrease.

### BRIEF DESCRIPTION OF THE DRAWINGS

FIG. 1 is a schematic perspective view of a stroller according to an embodiment of the present disclosure, where a portion of the stroller is shown in an exploded state.

FIG. 2 is a schematic diagram of a stroller in a folded state according to an embodiment of the present disclosure;

FIG. 3 is a schematic enlarged view of the area A in FIG. 1;

FIG. 4 is a schematic enlarged view of the area B in FIG. 1;

FIG. 5 is a schematic front view of a stroller according to an embodiment of the present disclosure, where a portion of the stroller is shown in an exploded state;

FIG. 6 is a schematic structural diagram of a first connecting base of a folding mechanism according to an embodiment of the present disclosure;

FIG. 7 is a schematic structural diagram of a damping member of a folding mechanism according to an embodiment of the present disclosure;

FIG. 8 is a schematic structural diagram of a folding mechanism according to an embodiment of the present disclosure, showing that the first connecting base and a second connecting base are in a first rotation position;

FIG. 9 is a schematic structural diagram of a folding mechanism according to an embodiment of the present disclosure, showing that the first connecting base and a second connecting base are in a second rotation position;

FIG. 10 is a schematic structural diagram of a damping member and a second boss of a folding mechanism according to another embodiment of the present disclosure;

FIG. 11 is a schematic structural diagram of the damping member and the second boss of a folding mechanism according to yet another embodiment of the present disclosure;

FIG. 12 is a schematic perspective view of a stroller with another folding mechanism according to an embodiment of the present disclosure, where a portion of the stroller is shown in an exploded state;

FIG. 13 is a schematic structural diagram of a second connecting base of the other folding mechanism according to an embodiment of the present disclosure;

FIG. 14 is a schematic structural diagram of a damping member of the other folding mechanism according to an embodiment of the present disclosure;

FIG. 15 is a schematic diagram showing that a stroller with the other folding mechanism is in a unfolded state according to an embodiment of the present disclosure, where a portion of a second rotating connecting portion that is engaged with a first rotating connecting portion is shown, to facilitate observation of relative rotation of the first rotating connecting portion and the second rotating connecting portion;

FIG. 16 is a schematic diagram showing that a stroller with the other folding mechanism is in a folding process according to an embodiment of the present disclosure, where a portion of a second rotating connecting portion that is engaged with a first rotating connecting portion is shown, to facilitate observation of relative rotation of the first rotating connecting portion and the second rotating connecting portion; and

FIG. 17 is a schematic diagram showing that a stroller with the other folding mechanism is in a folded state according to an embodiment of the present disclosure, where a portion of a second rotating connecting portion that is engaged with a first rotating connecting portion is shown, to facilitate observation of relative rotation of the first rotating connecting portion and the second rotating connecting portion.

### LIST OF REFERENCE SIGNS

100: leg assembly; 110: front leg; 120: rear leg; 130: brake mechanism; 200: first connecting base; 210: first rotating connecting portion; 220: first leg connecting portion; 230: first boss; 231: fixing groove; 300: second connecting base; 310: second rotating connecting portion; 311: cavity; 320: second leg connecting portion; 330: second boss; 331: friction portion; 332: idling portion; 333: transition section; 400: handlebar; 410: wrapping layer; 500: damping member; 501: concave position; 502: groove; 510: bump; 520: protruding portion; 530: damping portion; 540: limiting portion; 541: limiting portion body; 542: connection section; 550: first connecting portion; 551: mounting groove; 560: close-fitting member; 561: connecting side; 600: wheel; 700: elastic member; 800: first connecting base; 810: first rotating connecting portion; 820: first leg connecting portion; 830: friction portion; 900: second connecting base; 910: second rotating connecting portion; 9101: axis; 911: protruding portion; 912: first chamber; 913: second chamber; 920: second leg connecting portion; 930: stopper; 940: second connecting portion; 950: abutting member.

### DETAILED DESCRIPTION

In order to make the above objectives, features, and advantages of the present disclosure more obvious and understandable, specific implementations of the present disclosure are described in detail below with reference to the accompanying drawings. In the following description, many specific details are set forth in order to fully understand the present disclosure. However, the present disclosure can be implemented in many other ways different from those described herein, and those skilled in the art can make similar improvements without departing from the connotation of the present disclosure. Therefore, the present disclosure is not limited by specific embodiments disclosed below.

In the description of the present disclosure, it is to be understood that the orientation or position relationships indicated by the terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, and the like are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

In addition, the terms “first” and “second” are used for descriptive purposes only, which cannot be construed as indicating or implying a relative importance, or implicitly specifying the number of the indicated technical features. Therefore, the features defined with “first” and “second” may explicitly or implicitly include at least one feature. In the description of the present disclosure, the term “a plurality of” means at least two, such as two or three, unless otherwise defined explicitly and specifically.

In the present disclosure, unless otherwise specified and defined explicitly, the terms “mount”, “connect”, “join”, and “fix” should be understood in a broad sense, which may be, for example, a fixed connection, a detachable connection, or an integrated structure; a mechanical connection or an electrical connection; or a direct connection, an indirect connection via an intermediate medium, an internal connection between two elements, or interaction between two elements, unless otherwise specified. Those of ordinary skill in the art can understand specific meanings of these terms in the present disclosure according to specific situations.

In the present disclosure, unless otherwise explicitly specified and defined, the expression of a first feature being “on” or “under” a second feature may refer to the first feature being in direct contact with the second feature, or the first feature being in indirect contact with the second feature via an intermediate medium. Furthermore, the expression of the first feature being “over”, “above” and “on top of” the second feature may refer to the first feature being directly above or obliquely above the second feature, or only refers to the level of the first feature being higher than that of the second feature. The expression of the first feature being “below”, “underneath” or “under” the second feature may refer to the first feature being directly underneath or obliquely underneath the second feature, or only refers to the level of the first feature being lower than that of the second feature.

It is to be noted that when an element is referred to as being “fixed to” or “arranged on” another element, the element may be directly disposed on the other element or an intermediate element may exist between them. When an element is considered to be “connected to” another element, the element may be directly connected to the other element or an intermediate element may exist between them.

A folding mechanism is widely used in operations such as clamping, folding, and twisting. For convenience of description, description will be provided below based on an embodiment in which the folding mechanism as referred to in the present disclosure is applied to a leg assembly 100 of a stroller to prevent a collision of a handlebar 400.

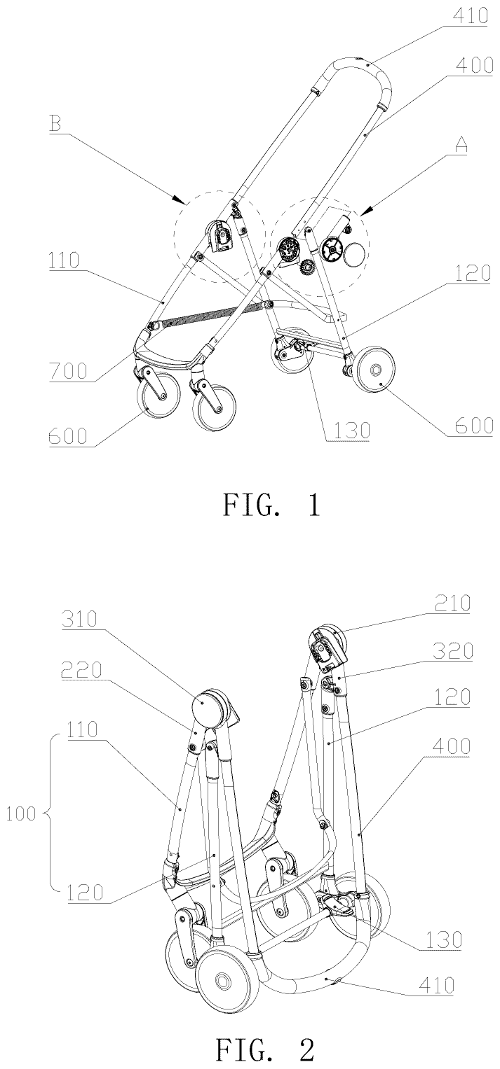

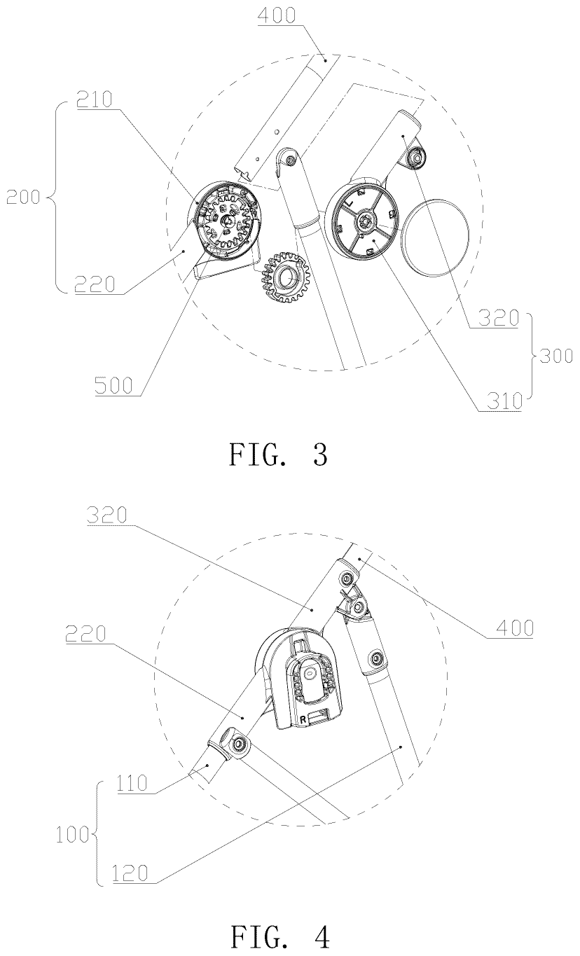

Referring to FIG. 1 to FIG. 4, FIG. 1 and FIG. 2 are respectively schematic diagrams of a stroller in two states according to an embodiment of the present disclosure, and FIG. 3 and FIG. 4 are respectively partial enlarged views of FIG. 1 and FIG. 2, to show a folding mechanism. A folding mechanism provided in an embodiment of the present disclosure forms a part of the leg assembly 100 of the stroller. The folding mechanism includes a first connecting base 200, a second connecting base 300, and a damping member 500. The second connecting base 300 is connected to the first connecting base 200 and is rotatable between a first rotation position and a second rotation position relative to the first connecting base 200. The damping member 500 is arranged between the first connecting base 200 and the second connecting base 300, and the damping member 500 is connected to the first connecting base 200. When the second connecting base 300 rotates relative to the first connecting base 200, the damping member 500 and the second connecting base 300 rotate relative to each other, and in at least one stage during the relative rotation of the second connecting base 300 and the first connecting base 200, at least part of the damping member 500 in a circumferential direction abuts against a circumferential inner wall of the second connecting base 300. Specifically, in the at least one stage during the relative rotation of the second connecting base 300 and the first connecting base 200, at least part of a circumferential outer side of the damping member 500 abuts against the circumferential inner wall of the second connecting base 300.

According to the folding mechanism provided in the present disclosure, through the arrangement of the damping member 500 between the first connecting base 200 and the second connecting base 300, a rotation speed of the second connecting base 300 relative to the first connecting base 200 can be decreased. When the folding mechanism is applied to a stroller, forceful collisions between structures of a stroller can be prevented, improving durability of the stroller.

Specifically, the stroller as referred to in the present disclosure includes the leg assembly 100 and the handlebar 400. The leg assembly 100 includes a plurality of legs. In this embodiment, the leg assembly 100 includes a front leg 110 and two rear legs 120. As shown in FIG. 1 and FIG. 2, the front leg 110 is U-shaped, and two wheels 600 are provided at the bottom of the front leg 110. The two rear legs 120 are arranged in parallel, and the two rear legs 120 are arranged at an angle with the front leg 110 respectively. Two wheels 600 are also provided at the bottom of the two rear legs 120 so that the entire stroller can move on the ground. A brake mechanism 130 is also provided between the two rear legs 120. By pressing or stepping on the brake mechanism 130, the two wheels 600 connected to the two rear legs 120 can be braked.

Exemplarily, in this embodiment, referring to FIG. 2, FIG. 3, and FIG. 4, the first connecting base 200 includes a disk-shaped first rotating connecting portion 210 and a first leg connecting portion 220. The first leg connecting portion 220 is connected to a circumferential side edge of the first rotating connecting portion 210, and an end of the first leg connecting portion 220 away from the first rotating connecting portion 210 is connected to the front leg 110. The second connecting base 300 includes a disk-shaped second rotating connecting portion 310 and a second leg connecting portion 320, and the second rotating connecting portion 310 is rotatably connected to the first rotating connecting portion 210, which may rotate relative to each other. The second leg connecting portion 320 is hinged to the rear leg 120, and an end of the second leg connecting portion 320 away from the second rotating connecting portion 310 is connected to the handlebar 400.

A user may push the entire stroller to move through the handlebar 400. The handlebar 400 is U-shaped, and an arc-shaped portion of the handlebar 400 is provided with a wrapping layer 410 to improve grip feel. In this embodiment, the wrapping layer 410 is a leather layer to improve wear-resistance and anti-slip performance.

Referring to FIG. 3, the damping member 500 is arranged between the first rotating connecting portion 210 and the second rotating connecting portion 310. In this embodiment, the damping member 500 is fixed to the first rotating connecting portion 210. The handlebar 400 is rotated to drive the first rotating connecting portion 210 and the second rotating connecting portion 310 to rotate relative to each other. In at least one stage during the relative rotation of the first rotating connecting portion 210 and the second rotating connecting portion 310, the damping member 500 abuts against the second rotating connecting portion 310 and generates friction, increasing resistance and decreasing a speed of relative rotation of the first rotating connecting portion 210 and the second rotating connecting portion 310.

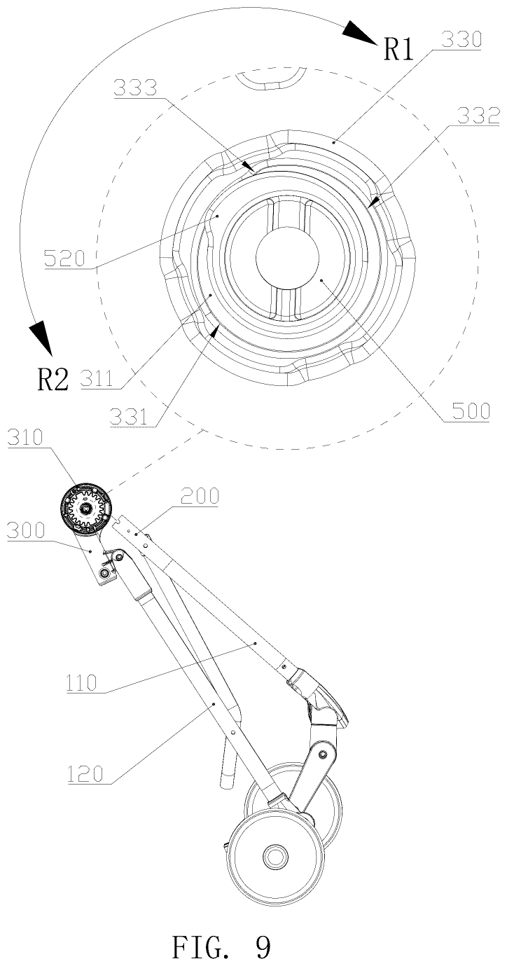

For convenience of description, exemplarily, as shown in FIG. 1, the first connecting base 200 and the second connecting base 300 are in a first rotation position, and the stroller is in a unfolded state. Corresponding thereto, the handlebar 400 is in a unfolded state and can be used by the user to push the stroller. As shown in FIG. 2, the first connecting base 200 and the second connecting base 300 are in a second rotation position, and the stroller is in a folded state. Corresponding thereto, the leg assembly 100 and the handlebar 400 are in folded states, in which case the stroller takes up a minimal space and is easy to be stored. For the convenience of description, a direction in which the second connecting base 300 rotates relative to the first connecting base 200 towards the first rotation position is defined as a first direction R1, and a direction in which the second connecting base 300 rotates relative to the first connecting base 200 towards the second rotation position is defined as a second direction R2. The first direction R1 and the second direction R2 are opposite to each other (refer to FIGS. 9 to 11, and 15 to 17). It should be noted that although the first direction RI and the second direction R2 are defined based on the rotation of the second connecting base 300 relative to the first connecting base 200, this does not mean that during the unfolding and folding process of the stroller according to this application, the first connecting base 200 remains stationary while only the second connecting base 300 rotates. Those skilled in the art can fully understand that during the unfolding and folding process of the stroller according to this application, the first connecting base 200 and the second connecting base 300 rotate relative to each other. Therefore, the first direction R1 can also be defined as a direction in which the first connecting base 200 rotates relative to the second connecting base 300 towards the second rotation position, and the second direction R2 can also be defined as a direction in which the first connecting base 200 rotates relative to the second connecting base 300 towards the first rotation position.

It may be understood that when the stroller is folded, a relative position of the first connecting base 200 and the second connecting base 300 is transformed from the first rotation position in FIG. 1 to the second rotation position in FIG. 2. Under a combined action of a downward pressing force exerted by the user and the weight of the frame of stroller itself, taking the handlebar 400 in FIG. 3 as an example, the handlebar 400 rotates clockwise with a center of the second rotating connecting portion 310 as a center of a circle. When the relative position of the first connecting base 200 and the second connecting base 300 is transformed to the second rotation position, the wrapping layer 410 is adjacent to the brake mechanism 130. Through the arrangement of the damping member 500 between the first rotating connecting portion 210 and the second rotating connecting portion 310, a downward pressing speed of the handlebar 400 can be decreased, which prevents possible damage to the wrapping layer 410 due to a strong collision of the wrapping layer 410 with the brake mechanism 130 and effectively prolongs the service life.

Meanwhile, it may also be understood that when the handlebar 400 is pressed down, the front leg 110 and the rear leg 120 also move closer to each other, thus showing a switching from the state shown in FIG. 1 to the state shown in FIG. 2.

In other embodiments, the first connecting base 200 may alternatively be arranged integrally with the front leg 110, i.e., the first connecting base 200 is part of the front leg 110. Similarly, the second connecting base 300 may alternatively be arranged integrally with the rear leg 120, i.e., the second connecting base 300 is part of the rear leg 120.

In other embodiments, the damping member 500 may alternatively be fixed to the second rotating connecting portion 310. When the handlebar 400 is rotated, the second rotating connecting portion 310 may rotate relative to the first rotating connecting portion 210. In at least one stage during the relative rotation of the first rotating connecting portion 210 and the second rotating connecting portion 310, the damping member 500 generates friction with the first rotating connecting portion 210, increasing resistance and decreasing the speed of relative rotation of the first rotating connecting portion 210 and the second rotating connecting portion 310.

In some embodiments, a side of the first connecting base 200 facing the second connecting base 300 is provided with a first boss 230, an end of the first boss 230 adjacent to the second connecting base 300 is provided with a fixing groove 231, the damping member 500 is provided with a bump 510, and the bump 510 is nested in the fixing groove 231 so that the damping member 500 is fixed to the first connecting base 200.

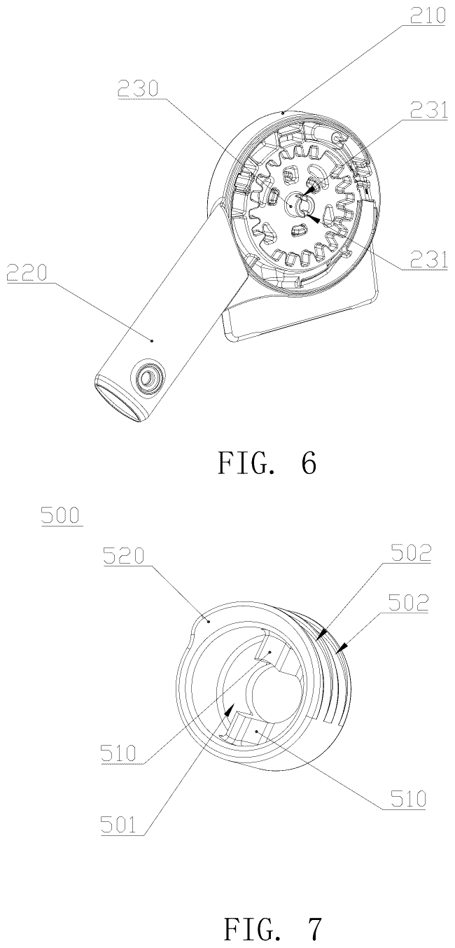

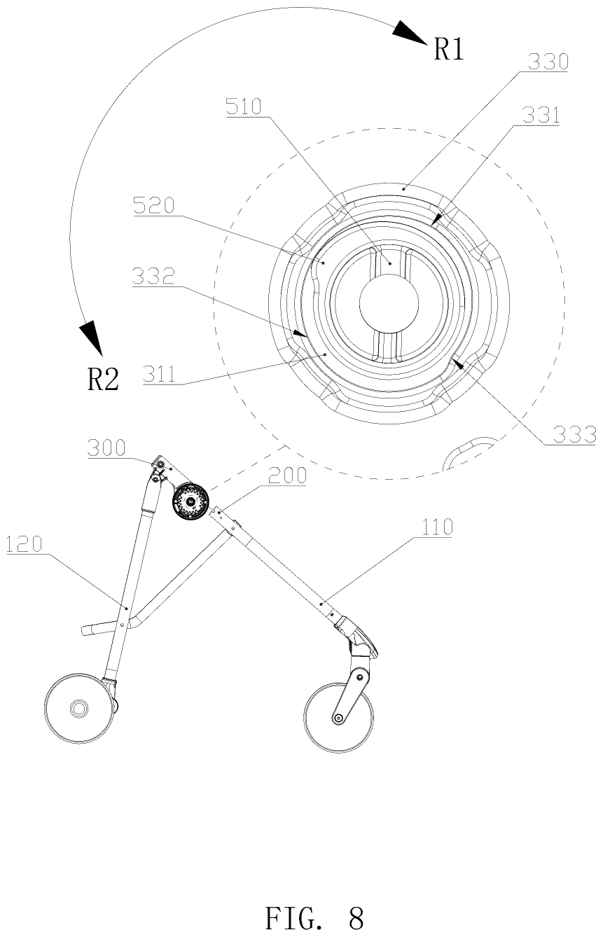

Referring to FIG. 3, FIG. 6, and FIG. 7, exemplarily, the first boss 230 is arranged at a center of the first rotating connecting portion 210 and is located on a side of the first rotating connecting portion 210 facing the second rotating connecting portion 310. The first boss 230 is in the shape of a cylinder, and the middle of the first boss 230 is provided with a perforation. The first boss 230 is provided with a fixing groove 231. In this embodiment, the fixing groove 231 includes two sub-grooves arranged oppositely. The damping member 500 is also in the shape of a cylinder. An end of the damping member 500 is provided with a concave position 501, and the concave position 501 matches the first boss 230 so that the damping member 500 can cover the first boss 230. The damping member 500 forms an annular inner wall at the concave position 501. Two bumps 510 are arranged at the annular inner wall. The two bumps 510 respectively fit the two sub-grooves of the fixing groove 231 and may be nested in the two sub-grooves respectively. The first connecting base 200 is provided with the first boss 230 having the fixing groove 231, the inner wall of the damping member 500 is provided with the bump 510, and the bump 510 is engaged with the fixing groove 231, so that the damping member 500 is firmly fixed on the first connecting base 200.

In some embodiments, the second connecting base 300 is provided with a cavity 311, and at least part of the damping member 500 is located in the cavity 311. Along a direction of relative rotation of the first connecting base 200 and the second connecting base 300 or along a circumferential direction of the damping member 500, an outer peripheral side of the damping member 500 is provided with a protruding portion 520. The protruding portion 520 is configured to abut against an inner wall of the second connecting base 300 located at an edge of the cavity 311 in at least one stage during the relative rotation of the second connecting base 300 and the first connecting base 200.

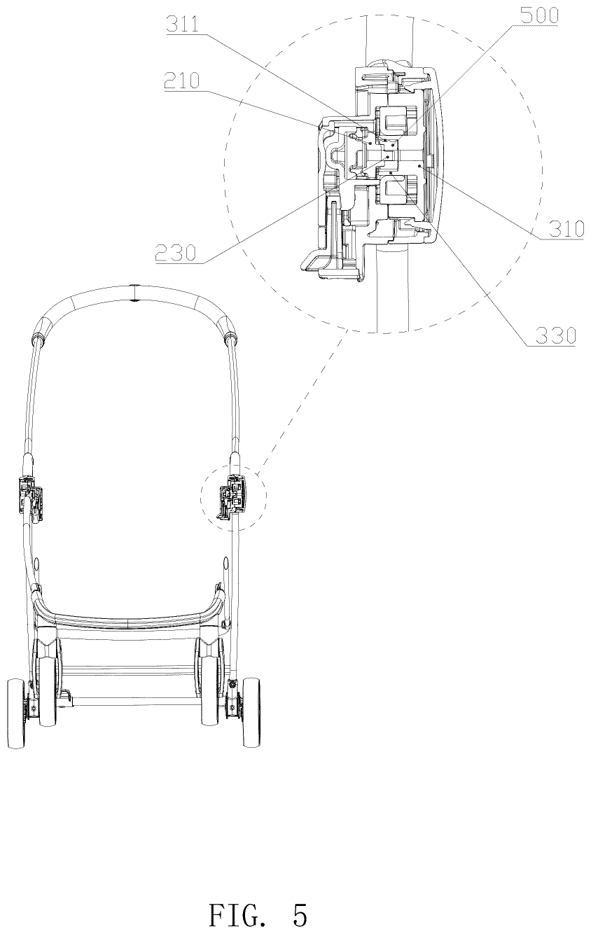

The second rotating connecting portion 310 is provided with a cavity 311. Referring to FIG. 5 and FIG. 7, exemplarily, a side of the second rotating connecting portion 310 facing the first rotating connecting portion 210 is provided with a second boss 330. The second boss 330 is provided with a through hole and a side of the second boss 330 adjacent to the first boss 230 is provided with a cavity 311. The cavity 311 is configured to accommodate the damping member 500. It may be understood that an inner wall of the second boss 330 defines a range of the cavity 311. A circumferential outer side edge of the damping member 500 is provided with the protruding portion 520. When the second rotating connecting portion 310 rotates relative to the first rotating connecting portion 210, the protruding portion 520 generates friction with the inner wall of the second boss 330 to increase damping and prevent excessively fast rotation of the handlebar 400 relative to the first connecting base 200 and the second connecting base 300. The second connecting base 300 is provided with the cavity 311 and at least part of the damping member 500 is arranged in the cavity 311, so that the protruding portion 520 stably generates friction with the inner wall of the second boss 330, and a deceleration effect on the handlebar 400 can be more uniform and obvious.

In this embodiment, the damping member 500 is located in the cavity 311, and the inner wall of the second boss 330 prevents detachment of the damping member 500 from the cavity 311 and improves stability of the friction between the damping member 500 and the inner wall of the second boss 330.

In this embodiment, the second boss 330 and the second rotating connecting portion 310 are integrally formed, which provides higher connection stability and can save mounting time and cost. In other embodiments, the second boss 330 and the second rotating connecting portion 310 may alternatively be integrally mounted by bonding, screwing, or welding, which makes it easy to replace the second boss 330 made of different materials according to an actual requirement. If the second boss 330 made of a wear-resistant material is selected, the service life is longer. Alternatively, second bosses 330 of different sizes may be selected and mounted according to actual requirements, to match damping members 500 of different sizes, which improves use compatibility.

In some embodiments, the inner wall of the second connecting base 300 located at the edge of the cavity 311 is provided with a friction portion 331 protruding inward, and the friction portion 331 is configured to be in interference fit with the protruding portion 520 in at least one stage during the relative rotation of the second connecting base 300 and the first connecting base 200.

Exemplarily, referring to FIG. 8 and FIG. 9, viewed along an axial direction of the second boss 330, the inner wall of the second boss 330 includes a friction portion 331 and an idling portion 332. A distance between the friction portion 331 and a center of the second boss 330 is smaller than a distance between the protruding portion 520 and the center of the second boss 330, so that the protruding portion 520 and the friction portion 331 form interference fit, and then friction can be formed when the second boss 330 and the damping member 500 rotate relative to each other. A distance between the idling portion 332 and the center of the second boss 330 is larger than the distance between the protruding portion 520 and the center of the second boss 330, so that when the first connecting base 200 and the second connecting base 300 rotate relative to each other to a certain position and the protruding portion 520 corresponds to the idling portion 332, the protruding portion 520 does not come into contact with the inner wall of the second boss 330, and the relative rotation between the second boss 330 and the damping member 500 does not cause friction. By arranging the friction portion 331 and the idling portion 332 on the inner wall of the second boss 330, the first connecting base 200 and the second connecting base 300 may be subjected to a frictional force generated by the damping member 500 when rotating relative to each other within a specific rotation angle, and when the structure is applied to the stroller, the handlebar 400 may be limited by a moderate amount of resistance when pulled up or pressed down, to prevent a collision due to excessively fast rotation of the handlebar 400.

In an exemplary embodiment, viewed along the axial direction of the second boss 330, the inner wall of the second boss 330 is in a continuous state and may be approximately seen as gradually converging towards an axis of the second boss 330 in a clockwise direction. “Converge” in the present disclosure means converging towards the axis of the second boss 330, that is, converging towards axes of the first connecting base 200 and the second connecting base 300. As shown in FIG. 8, there is a transition section 333 in a lower right direction of the inner wall of the second boss 330, and the transition section 333 causes that inner wall of the second boss 330 that spirally converges to form a smooth coherent state.

It may be understood that referring to FIG. 8, there is a specific point (not shown) on the inner wall of the second boss 330, and this point exactly abuts against the protruding portion 520. The inner wall of the second boss 330 is regarded as the friction portion 331 between the point and the transition section 333 in a clockwise direction. The inner wall of the second boss 330 is regarded as the idling portion 332 between the point and the transition section 333 in a counterclockwise direction.

In an exemplary embodiment, both the friction portion 331 and the idling portion 332 are the inner wall of the second boss 330. In other embodiments, the friction portion 331 and the idling portion 332 may be wear-resistant blocks bonded, welded, or embedded into the inner wall of the second boss 330.

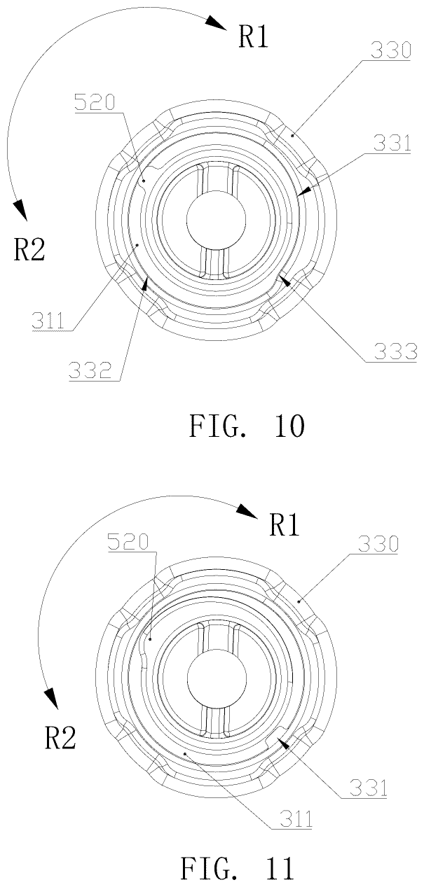

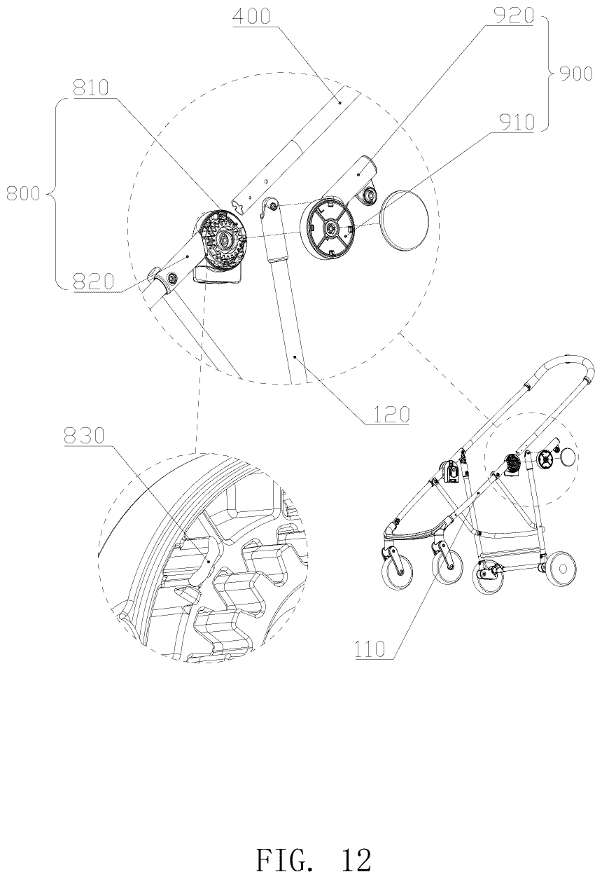

In another embodiment of the present disclosure, referring to FIG. 10, along the first direction R1, an edge of one of the protruding portion 520 and the friction portion 331 is in the shape of a convergent arc, and another of the protruding portion 520 and the friction portion 331 is a protruding pillar. Referring to FIG. 10, in this embodiment, the protruding portion 520 is a protruding pillar, and the friction portion 331 is arranged on the inner wall of the second boss 330 and is formed as a convergent arc-shaped section along the first direction R1. During rotation of the second connecting base 300 relative to the first connecting base 200, when the protruding portion 520 corresponds to the friction portion 331, the protruding portion 520 continuously abuts against the friction portion 331, and frictional resistance continues to be generated within a certain rotation angle. It could be understood that due to the friction portion 331 formed as the convergent arc-shaped section along the first direction R1, during the folding process of the stroller, when the second connecting base 300 rotates relative to the first connecting base 200 along the second direction R2, a position where the protruding portion 520 abuts against the friction portion 331 gradually converges, the frictional resistance gradually increases. In this way, when the handlebar 400 is pressed down so that the first connecting base 200 and the second connecting base 300 rotate from the first rotation position to the second rotation position, the second boss 330 rotates counterclockwise relative to the damping member 500 (along the second direction R2). A degree of matching between the protruding portion 520 and the friction portion 331 gradually increases, a contact area gradually increases, a degree of interference fit also gradually increases, and the frictional resistance formed gradually increases. When the handlebar 400 rotates to the second rotation position, the contact area between the protruding portion 520 and the friction portion 331 is maximum in this case, the degree of interference fit is the highest, and the frictional resistance generated is the largest, which can prevent further movement of the handlebar 400, prevent a collision with the brake mechanism 130 as much as possible, and help hold the handlebar 400 at the second rotation position to maintain the folded state. In this way, when the user presses down the handlebar 400, the resistance gradually increases, and when the handlebar 400 is lifted up, the resistance gradually decreases. This structure is more in line with the user's habit of applying a force to the handlebar 400, and effectively prevents a situation where the handlebar 400 gets stuck for no reason or cannot remain stationary stably.

Furthermore, when the folding mechanism is applied to the stroller, regardless of whether the handlebar 400 is pressed down or pulled up, the damping member 500 can continuously increase the frictional resistance. Moreover, as the handlebar 400 is pressed deeper, the frictional resistance gradually increases. As the handlebar 400 is pulled up higher, the frictional resistance gradually decreases, which is more in line with a force application habit.

In some other embodiments, referring to FIG. 11, the friction portion 331 may alternatively be a protruding pillar arranged on the inner wall of the second boss 330, while the protruding portion 520 has a convergent arc-shaped outer wall. During relative rotation of the first connecting base 200 and the second connecting base 300, the friction portion 331 and the protruding portion 520 may also continue to abut in a certain stage to generate frictional resistance, which can also achieve a similar effect to the above embodiment.

In some embodiments, along the first direction R1, edges of the protruding portion 520 and the friction portion 331 are both in shapes of convergent arcs. In this way, during the relative rotation of the second connecting base 300 and the first connecting base 200, the protruding portion 520 and the friction portion 331 have a better matching effect, a larger abutment area, and are more wear-resistant, thereby improving durability of the damping member 500.

In some embodiments, along the first direction R1, an edge of the protruding portion 520 is in the shape of a convergent arc, and the inner wall of the second connecting base 300 is in the shape of a ring. In this case, the inner wall of the entire second boss 330 serves as the friction portion 331, and the protruding portion 520 and the inner wall of the second boss 330 always maintain an interference connection state. In this way, when the first connecting base 200 and the second connecting base 300 rotate relative to each other, the protruding portion 520 and the friction portion 331 can continue to generate stable frictional resistance. Alternatively, along the first direction R1, the inner wall of the second connecting base 300 (that is, the friction portion 331) is in the shape of a convergent arc, and the edge of the protruding portion 520 is in the shape of a ring.

In some embodiments, the damping member 500 is provided with a groove 502, and the groove 502 is located in the protruding portion 520 and corresponds to the friction portion 331 or the idling portion 332. Referring to FIG. 7, in this embodiment, two grooves 502 are provided, the two grooves 502 are arranged in parallel along an axial direction of the damping member 500 and are arranged along a circumferential side of the damping member 500, and at least part of the groove 502 is located in the protruding portion 520, so that the protruding portion 520 is divided into three parts in the axial direction of the damping member 500. Certainly, the grooves 502 may not be arranged in parallel. Through the arrangement of the groove 502 in the damping member 500, the protruding portion 520 may be divided into multiple parts, which can prevent an incapability to fully exert a damping effect caused by insufficient friction between the protruding portion 520 and the inner wall of the second boss 330 resulted from abutment of only part of the protruding portion 520 against the inner wall of the second boss 330 due to a shape error of the protruding portion 520, and can also prevent an influence on folding of the frame caused by jamming due to an excessively large contact area between the damping member 500 and the inner wall of the second boss 330.

In some embodiments, the damping member 500 is an elastic member. The elastic member is a concept opposite to a rigid member. Specifically, the damping member 500 in the present disclosure is made of a soft material, which may be rubber, TPE (synthetic rubber), silicone, a Hytrel elastomer, or the like. The elastic member is selected as the damping member 500, which can reduce a probability of jamming when the second connecting base 300 and the damping member 500 rotate relative to each other due to excessive material stiffness, and reduce a degree of wear of the second connecting base 300.

The present disclosure further provides a stroller. The stroller includes the above-mentioned folding mechanism, the leg assembly 100, universal rollers arranged at the bottom of the front leg 110 and the rear leg 120, the brake mechanism 130 arranged between the two rear legs 120, and the like. The stroller may be a wagon cart, a baby carriage, or the like. In use, the stroller may be moved by the handlebar 400, and when not in use, the handlebar 400 may be put down to fold the front leg 110 and the rear leg 120, thereby reducing an occupied space. The stroller also has the above damping member 500, which can decrease a rotation speed when the handlebar 400 is retracted down or pulled up, reduce a probability of collision between the handlebar 400 and the brake mechanism 130, effectively protect the wrapping layer 410, and prolong the service life.

The stroller further includes an elastic member 700. As shown in FIG. 1, two ends of the elastic member 700 are connected to the front leg 110 and the rear leg 120 respectively, and when the handlebar 400 is raised, that is, when at the first rotation position, the elastic member 700 is in a stretched state. It may be understood that the elastic member 700 generates a restoring force when stretched, so that the front leg 110 and the rear leg 120 have a tendency to move together, making it easier to fold.

In this embodiment, the elastic member 700 is a tension spring. In other embodiments, the elastic member 700 may alternatively be replaced with an elastic band or the like.

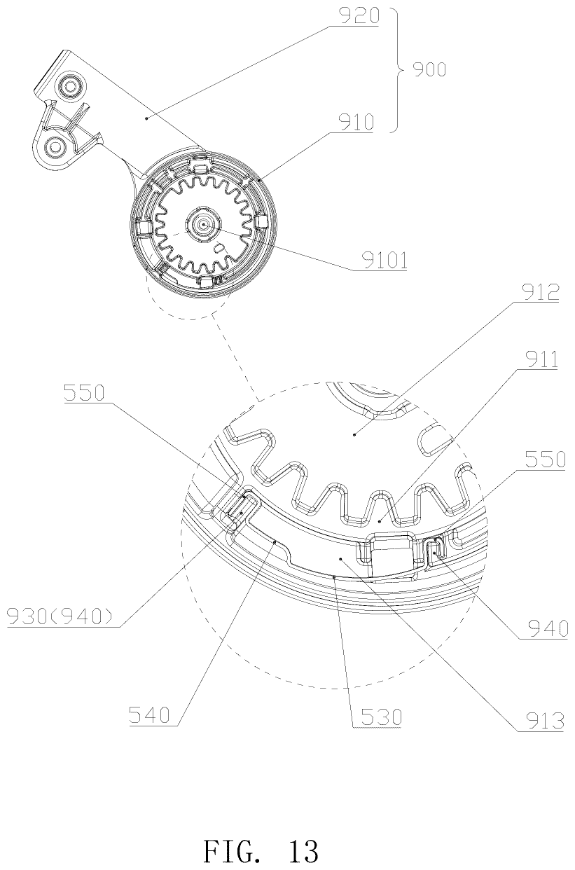

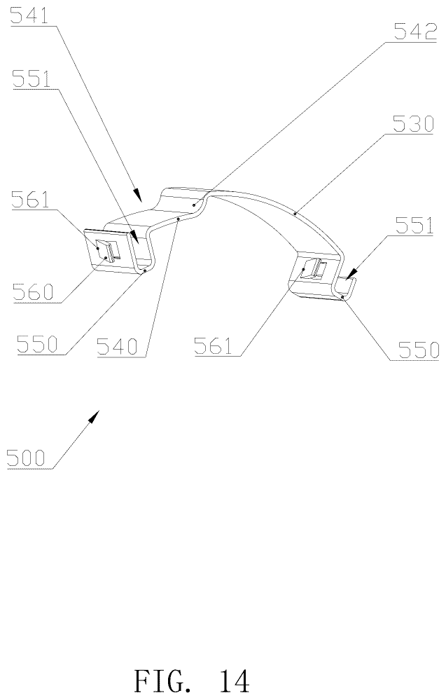

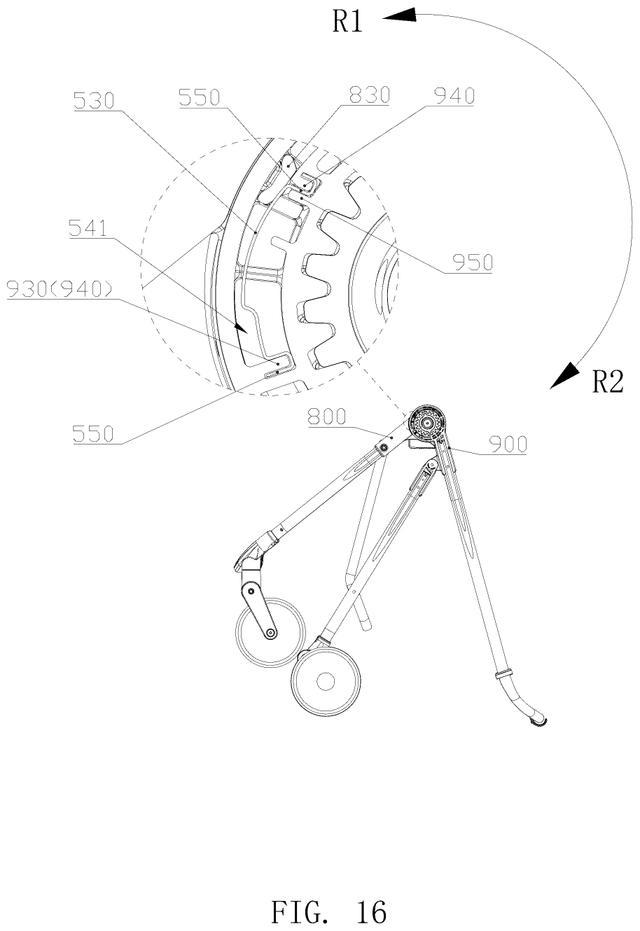

Another embodiment of the present disclosure further provides another folding mechanism. The folding mechanism is also applicable to the above-mentioned stroller. Referring to FIG. 12, FIG. 13, and FIG. 15, the folding mechanism includes a first connecting base 800, a second connecting base 900, and a damping member 500. The first connecting base 800 is rotatable between a first rotation position and a second rotation position relative to the second connecting base 900. In this embodiment, the first rotation position corresponds to a position where the handlebar 400 is unfolded, and the second rotation position corresponds to a position where the handlebar 400 is folded. Certainly, the corresponding relationship may alternatively be reversed, that is, the first rotation position corresponds to the position where the handlebar 400 is folded, and the second rotation position corresponds to the position where the handlebar 400 is unfolded. The first connecting base 800 is provided with a friction portion 830. The friction portion 830 protrudes inward from an inner wall of the first connecting base. The second connecting base 900 is connected to the first connecting base 800 and is rotatable between the first rotation position and the second rotation position relative to the first connecting base 800. The damping member 500 is arranged on the second connecting base 900. In at least one stage during the relative rotation of the second connecting base 900 and the first connecting base 800, the damping member 500 abuts against the friction portion 830 to decrease a speed of relative rotation of the second connecting base 900 and the first connecting base 800.

Similar to the first connecting base 200 and the second connecting base 300 in the above embodiments, in this embodiment, specifically, the first connecting base 800 includes a disk-shaped first rotating connecting portion 810 and a first leg connecting portion 820, the first leg connecting portion 820 is connected to a circumferential side edge of the first rotating connecting portion 810, and the first leg connecting portion 820 is connected to the front leg 110. Similar to the first connecting base 800, the second connecting base 900 also includes a disk-shaped second rotating connecting portion 910 and a second leg connecting portion 920, the second rotating connecting portion 920 is connected to a circumferential side edge of the second rotating connecting portion 910, the second leg connecting portion 920 is hinged to the rear leg 120, and an end of the second leg connecting portion 920 away from the second rotating connecting portion 910 is connected to the handlebar 400. The first rotating connecting portion 810 and the second rotating connecting portion 910 are coaxially arranged and connected to each other, and can rotate relative to each other, so that angles formed between the front leg 110 and the rear leg 120 and between the rear leg 120 and the handlebar 400 are changed to fold or unfold the stroller.

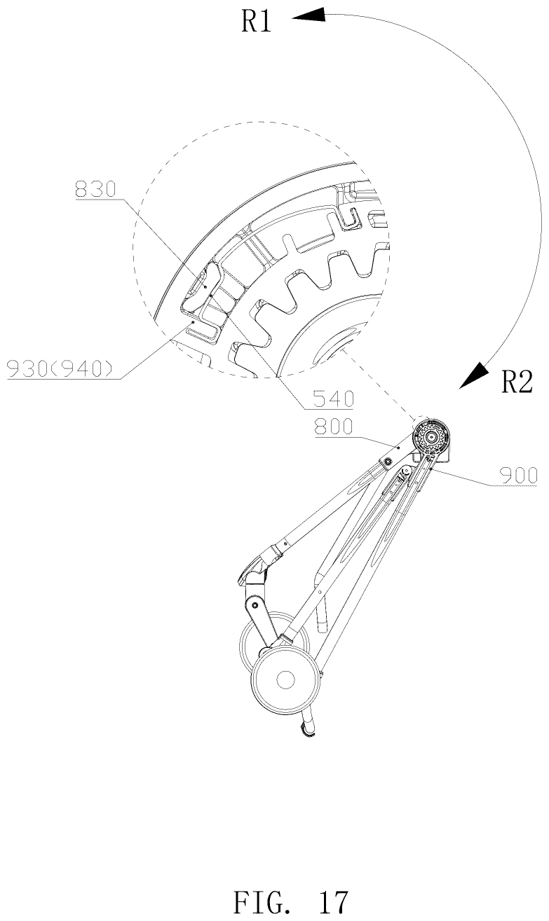

Referring to FIG. 12, FIG. 15, FIG. 16, and FIG. 17, the friction portion 830 is arranged on an inner side edge of the first rotating connecting portion 810, and the friction portion 830 protrudes from the inner side edge of the first rotating connecting portion 810 in a direction towards an axis of the first rotating connecting portion 810. Along a thickness direction of the first rotating connecting portion 810, the friction portion 830 protrudes from a circular end face of the first rotating connecting portion 810 to extend into the second rotating connecting portion 910. The friction portion 830 may be integrally formed with the first rotating connecting portion 810, or may be an independent component fixed to the inner side edge of the first rotating connecting portion 810, which is not limited herein.

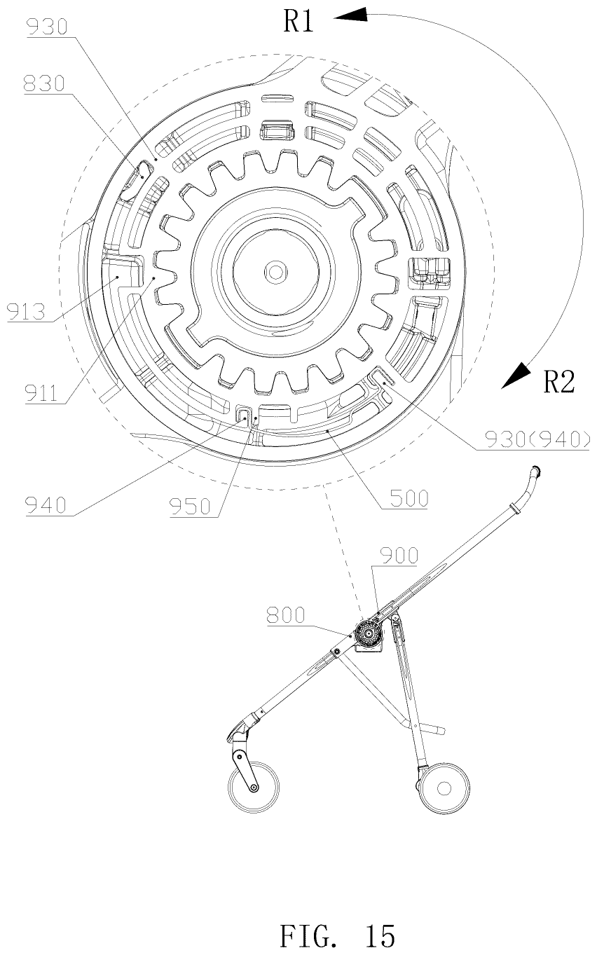

The damping member 500 is arranged in the second connecting base 900. As shown in FIG. 14, the damping member 500 is in the shape of a thin plate and includes a damping portion 530 and a limiting portion 540. Viewed from the perspective shown in FIG. 13, the damping portion 530 is in the shape of an arc. When the handlebar 400 is folded, the second connecting base 900 and the first connecting base 800 rotate relative to each other, and the damping portion 530 frictionally slides relative to the friction portion 830. Referring to FIG. 16, in this case, the damping portion 530 rotates into abutment against the friction portion 830, and since the friction portion 830 protrudes from an inner side edge of the second rotating connecting portion 910 by a distance greater than a distance between the damping portion 530 and the inner side edge of the second rotating connecting portion 910, the friction portion 830 may abut against an arc surface of the damping portion 530 to generate a frictional force, so that a frictional blocking effect is achieved during the relative rotation of the first connecting base 800 and the second connecting base 900, thereby decreasing a speed of relative rotation of the first connecting base 800 and the second connecting base 900.

Referring to FIG. 13, FIG. 14, and FIG. 17, the limiting portion 540 includes a connection section 542 extending from one side of the damping portion 530 and a limiting portion body 541 connected to the connection section 542, and the limiting portion body 541 is generally a straight section and is closer to an axis 9101 of the second rotating connecting portion 910 than the damping portion 530. That is, as shown in FIG. 13, when the damping member 500 is mounted in the second connecting base 900, a protruding distance of the damping portion 530 away from the axis 9101 is greater than a protruding distance of the limiting portion 540. In this embodiment, when the first connecting base 800 and the second connecting base 900 rotate relative to each other until the friction portion 830 is opposite to the limiting portion 540, the friction portion 830 falls into the limiting portion body 541, preventing relative rotation of the first connecting base 800 and the second connecting base 900 in an opposite direction, thereby preventing movement of the stroller from a fold state to an unfold state.

Preferably, referring to FIG. 14, the connecting section 542 of the limiting portion 540 and the damping portions 530 is in the shape of a transitional arc. When the stroller is required to be unfolded from the folded state again, that is, when the second connecting base 900 is required to be rotated from the second rotation position shown in FIG. 17 to the first rotation position shown in FIG. 15 relative to the first connecting base 800, the friction portion 830 can cross the connection section 542 in the shape of the transitional arc and reach a position of abutment against the damping portion 530 only by applying a certain pulling force to the second connecting base 900 along an unfolding direction, and the friction portion 830 can cross the damping member 500 and the second connecting base 900 can finally rotate relative to the first connecting base 800 to the first rotation position by continuously applying the pulling force in a same direction.

Optionally, referring to FIG. 13 and FIG. 15, the second rotating connecting portion 910 is provided with a plurality of bumps extending in a direction towards the first rotating connecting portion 810. A protruding portion 911 with a serrated inner side edge and a circumferential outer side edge located at the center of the second rotating connecting portion 910. The protruding portion 911 divides the second rotating connecting portion 910 into a first chamber 912 located inside the protruding portion 911 and a second chamber 913 located outside the protruding portion 911. It may be understood that viewed from the perspective of FIG. 13, the first chamber 912 is approximately circular, and the second chamber 913 is approximately arc-shaped. The serrated inner edge of the protruding portion 911 may fit a gear-shaped locking member (not shown). Specifically, the locking member may partially extend into the first chamber 912 in an axial direction of the second rotating connecting portion 910 and engage with the inner side edge of the protruding portion 911 to be locked with the second rotating connecting portion 910. The damping member 500 is mounted in the second chamber 913. The friction portion 830 also partially extends into the second chamber 913 in the axial direction of the second rotating connecting portion 910. In this way, when the first rotating connecting portion 810 and the second rotating connecting portion 910 rotate relative to each other, the friction portion 830 may abut against the damping member 500 in the second chamber 913 and generate friction to achieve a damping effect.

A stopper 930 is arranged in the second chamber 913. In this embodiment, two stoppers 930 are provided. As shown in FIG. 15, one stopper 930 is arranged between a circular inner wall of the second rotating connecting portion 910 and an outer side edge of the protruding portion 911 and is connected thereto, and the other stopper 930 is connected to the circular inner wall of the second rotating connecting portion 910 and extends in a direction towards the protruding portion 911. Certainly, the arrangement form of the stopper 930 is not limited thereto, as long as it is fixed in the second chamber 913. For example, the two stoppers 930 may both be arranged between the circular inner wall of the second rotating connecting portion 910 and the outer side edge of the protruding portion 911 and connected thereto. It may be understood that when the friction portion 830 moves in the second chamber 913, the two stoppers may both abut against the friction portion 830, to limit a movement stroke of the friction portion 830 in the second chamber 913, thereby limiting a relative rotational position between the first connecting base 800 and the second connecting base 900.

Specifically, referring to FIG. 17, when the stroller moves from the unfold state to the fold state, that is, when the first connecting base 800 rotates from the first rotation position to the second rotation position relative to the second connecting base 900, and when the friction portion 830 falls into the limiting portion body 541 and has a tendency to continue to move, the stopper 930 located on one side can stop the friction portion 830 and prevent detachment of the friction portion 830 from the limiting portion body 541, thereby preventing continuous relative rotation of the first connecting base 800 and the second connecting base 900. Alternatively, another rotation limiting structure may alternatively be arranged between the handlebar 400 and the front leg 110, which can also prevent excessive rotation between the first connecting base 800 and the second connecting base 900.

Specifically, referring to FIG. 15, when the stroller moves from the unfold state to the fold state, that is, when the first connecting base 800 rotates from the second rotation position to the first rotation position relative to the second connecting base 900, the friction portion 830 may abut against the stopper 930 located on the other side, and the stopper 930 can prevent continuous movement of the friction portion 830 in the second chamber 913, thereby preventing excessive rotation of the first connecting base 800 and the second connecting base 900.

When the folding mechanism is applied to the stroller, a frictional force generated by the friction portion 830 and the damping portion 530 can prevent a forceful collision between structures of the stroller caused by excessively fast folding of the handlebar 400, thereby improving durability of the stroller. The stopper 930 can prevent continuous relative rotation of the first connecting base 800 and the second connecting base 900, and the limiting portion 540 can prevent accidental unfolding of the stroller, so that the stroller can maintain the folded state more stably.

In some embodiments, the damping member 500 further includes a first connecting portion 550. Referring to FIG. 14, exemplarily, two ends of the damping member 500 in a length direction are each provided with the first connecting portion 550, and the first connecting portion 550 is approximately in the shape of a “C”-shaped hook to form a mounting groove 551. The second connecting base 900 is provided with a second connecting portion 940. In an exemplary embodiment, two second connecting portions 940 are arranged on the second rotating connecting portion 910. The second connecting portion 940 is a bump. The bump protrudes in a direction towards the axis center of the second rotating connecting portion 910. The two bumps are respectively embedded into the mounting groove 551 at an end of the damping member 500, so that the damping member 500 is more firmly mounted on the second connecting base 900, and the damping effect is more stably achieved during the relative rotation of the first connecting base 800 and the second connecting base 900. In this embodiment, the stopper 930 on one side may be used as one of the second connecting portions 940, which may reduce manufacturing costs.

In some embodiments, the second connecting base 900 is further provided with an abutting member 950. Taking the second connecting base 900 shown in FIG. 15 and FIG. 16 as an example, one abutting member 950 is arranged next to an end portion of the damping member 500 corresponding to the damping portion 530, and the abutting member 950 is spaced apart from the second connecting portion 940. A part of the first connecting portion 550 is sandwiched between the second connecting portion 940 and the abutting member 950. It may be understood that during the relative rotation of the first connecting base 800 and the second connecting base 900, the abutting member 950 abuts against an inner side of the damping portion 530, which can reduce deformation of the damping member 500, so that when the damping member 500 abuts against and rubs with the friction portion 830, the damping effect may not be weakened or even eliminated due to excessive deformation. Moreover, through a limiting effect of the second connecting portion 940 and the abutting member 950 on the first connecting portion 550, stability of the damping member 500 is improved.

In some embodiments, the damping member 500 is further provided with a close-fitting member 560. Exemplarily, the close-fitting member 560 is arranged on the first connecting portion 550 and is located on an outer side surface of the “C”-shaped hook, and an end of the close-fitting member 560 is connected to a surface of the first connecting portion 550. The close-fitting member 560 is arranged at an angle relative to a surface of the junction, and the close-fitting member 560 is elastic. When the close-fitting member 560 is pressed, the angle decreases, and the close-fitting member 560 undergoes elastic deformation, generating an elastic restoring force that causes the angle to have a tendency to restore. In this embodiment, a spacing between the second connecting portion 940 and the abutting member 950 is small, and the second connecting portion 940 abuts against the close-fitting member 560, pressing the close-fitting member 560, an angle with the surface of the first connecting portion 550 decreases, and the elastic restoring force is generated, so that the first connecting portion 550 is driven by the restoring force to stop at the abutting member 950. In this way, when the first connecting base 800 and the second connecting base 900 rotate relative to each other, the stability of the damping member 500 is further improved.

Optionally, the close-fitting member 560 is arranged integrally with the first connecting portion 550. Specifically, a part of a wall surface of the first connecting portion 550 that is parallel to the stopper 930 during the mounting is cut, so that the part is connected to the first connecting portion 550 on only one side to form the close-fitting member 560. A body of the close-fitting member 560 extends obliquely from the junction towards one side of the wall surface to form a structure similar to a cantilever. The close-fitting member 560 is generally in the shape of a rectangle, and a connecting side 561 of the close-fitting member 560 connected to the first connecting portion 550 extends along a direction perpendicular to a mounting direction of the first connecting portion 550. Alternatively, the close-fitting member 560 may be a component independent of the first connecting portion 550 and is connected to the first connecting portion 550 in various manners.

In some other embodiments, the close-fitting member 560 may alternatively be an elastic member such as a spring or a spring piece, and may also achieve a similar effect to the above embodiment. The structure and the form of the close-fitting member 560 are not limited in the present disclosure.

In some embodiments, the damping portion 530 is arranged in an involute manner in a direction towards the limiting portion 540. In other words, referring to FIG. 16, the damping portion 530 has a convergent arc shape along the second direction R2. Referring to FIG. 13, FIG. 14, and FIG. 15, it may be understood that during relative rotation of the first connecting base 800 and the second connecting base 900, when the friction portion 830 moves from an end of the damping portion 530 away from the limiting portion 540 to an end adjacent to the limiting portion 540, since the damping portion 530 is in an involute shape, a relative pushing and extruding force between the damping portion 530 and the friction portion 830 gradually increases, and a frictional force generated when the friction portion 830 slides relative to a surface of the damping portion 530 gradually increases. When this folding mechanism is applied to the stroller, as the user switches the stroller from the unfolded state to the folded state, the frictional force generated when the friction portion 830 slides relative to the surface of the damping portion 530 gradually increases, preventing a forceful collision between the structures of the stroller caused by an excessively fast rotational speed of the stroller during the folding, to further improve the durability of the stroller.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1. A folding mechanism, comprising:
a first connecting base;
a second connecting base connected to the first connecting base and rotatable between a first rotation position and a second rotation position relative to the first connecting base; and
a damping member arranged between the first connecting base and the second connecting base, wherein the damping member is connected to the first connecting base, and when the second connecting base rotates relative to the first connecting base, the damping member and the second connecting base rotate relative to each other, and in at least one stage during the relative rotation of the second connecting base and the first connecting base, at least part of the damping member in a circumferential direction abuts against a circumferential inner wall of the second connecting base.

2. The folding mechanism of claim 1, wherein the second connecting base is provided with a cavity, and at least part of the damping member is located in the cavity; and along a direction of relative rotation of the first connecting base and the second connecting base, an outer peripheral side edge of the damping member is provided with a protruding portion protruding outward, the protruding portion is configured to abut against a circumferential inner wall of the second connecting base located at an edge of the cavity in at least one stage during the relative rotation of the second connecting base and the first connecting base.

3. The folding mechanism of claim 2, wherein the inner wall of the second connecting base located at the edge of the cavity is provided with a friction portion protruding inward, the friction portion is configured to be in interference fit with the protruding portion in at least one stage during the relative rotation of the second connecting base and the first connecting base.

4. The folding mechanism of claim 3, wherein an edge of one of the protruding portion and the friction portion is in a shape of a convergent arc along a first direction, and another of the protruding portion and the friction portion is a protruding pillar.

5. The folding mechanism of claim 3, wherein edges of the protruding portion and the friction portion are in shapes of convergent arcs along a first direction.

6. The folding mechanism of claim 2, wherein an edge of one of the inner wall of the second connecting base and the protruding portion is in the shape of a convergent arc along a first direction, and an edge of another of the inner wall of the second connecting base and the protruding portion is in the shape of a ring.

7. The folding mechanism of claim 1, wherein a side of the first connecting base facing the second connecting base is provided with a first boss, an end of the first boss adjacent to the second connecting base is provided with a fixing groove, and the damping member is provided with a bump, the bump is nested in the fixing groove so that the damping member is fixed to the first connecting base.

8. The folding mechanism of claim 1, wherein the damping member is an elastic member.

9. A folding mechanism, comprising:
a first connecting base provided with a friction portion protruding inward from an inner wall of the first connecting base;
a second connecting base connected to the first connecting base and rotatable between a first rotation position and a second rotation position relative to the first connecting base; and
a damping member arranged on the second connecting base, in at least one stage during the relative rotation of the second connecting base and the first connecting base, the damping member abutting against the friction portion.

10. The folding mechanism of claim 9, wherein the damping member comprises a damping portion in the shape of an arc, and in at least one stage during the relative rotation of the second connecting base and the first connecting base, the damping portion abuts against the friction portion.

11. The folding mechanism of claim 9, wherein the damping member further comprises a limiting portion comprising:
a connection section extending from one side of the damping portion; and
a limiting portion body connected to the connection section, wherein the limiting portion body is generally a straight section,
when the first connecting base and the second connecting base rotate relative to each other until the friction portion is opposite to the limiting portion, the friction portion falls into the limiting portion body, and the connection section and the limiting portion body prevent a relative rotation of the first connecting base and the second connecting base in an opposite direction.

12. The folding mechanism of claim 10, wherein the damping member further includes a first connecting portion, which is provided with a mounting groove, and is arranged on at least one end of two ends of the damping member in a length direction,
the second connecting base is provided with a second connecting portion, which is embedded into the mounting groove, so that the damping member is fixed to the second connecting base.

13. The folding mechanism of claim 12, wherein the second connecting base is further provided with an abutting member, which is spaced apart from the second connecting portion, and at least part of the first connecting portion is arranged between the second connecting portion and the abutting member.

14. The folding mechanism of claim 12, wherein the damping member is further provided with a close-fitting member, which is arranged on the first connecting portion, and is pressed and arranged between the second connecting portion and the first connecting portion.

15. The folding mechanism of claim 14, wherein an end of the close-fitting member is connected to a surface of the first connecting portion, and the close-fitting member is arranged at an angle relative to the surface of the first connecting portion.

16. The folding mechanism of claim 15, wherein the close-fitting member is elastic, and when the close-fitting member is pressed, the angle decreases, and the close-fitting member generates an elastic restoring force that causes the angle to have a tendency to restore.

17. The folding mechanism of claim 10, wherein the second connecting base comprises:
a first chamber configured to engage with a locking member; and
a second chamber, wherein the damping member is mounted in the second chamber.

18. The folding mechanism of claim 17, wherein a stopper is arranged in the second chamber, when the first connecting base rotates relative to the second connecting base, the stopper is capable of abutting against the friction portion to limit a movement stroke of the first connecting base relative to the second connecting base.

19. The folding mechanism of claim 10, wherein the damping portion has a convergent arc shape along the second direction.

20. A stroller, comprising:
the folding mechanism of claim 1;
a leg assembly connected to the first connecting base, the leg assembly comprising a front leg and a rear leg, the front leg and the rear leg being arranged at an angle; and
an elastic member, two ends of the elastic member being connected to the front leg and the rear leg respectively, so that the angle formed by the front leg and the rear leg has a tendency to decrease.
